(19) United States
(12) Patent Application Publication
(10) Pub. No.: US 2017/0335137 A1
(43) Pub. Date: Nov. 23, 2017

(54) Compositions and Methods for Coating Surfaces

(71) Applicant: Beckman Coulter, Inc., Brea, CA (US)

(72) Inventors: Clarence Lew, Irvine, CA (US); Chitra K. Ratnayake, Yorba Linda, CA (US)

(21) Appl. No.: 15/522,452

(22) PCT Filed: Oct. 28, 2015
(86) PCT No.: PCT/IB2015/058320

§ 371 Date: Apr. 27, 2017

Related U.S. Application Data
(60) Provisional application No. 62/072,924, filed on Oct. 30, 2014.

(51) Int. Cl. C09D 183/08; B05D 3/00; B05D 7/22; C09D 5/00

(52) U.S. Cl. CPC C09D 183/08; C09D 5/00; B05D 3/007; B05D 7/22

(57) ABSTRACT

Embodiments described herein are directed to, among other things, compositions and methods for coating surfaces, including, but not limited to, coating a surface with a hydrophobic coating using alkoxysilanes. Coated surfaces are also provided.

### RELATED APPLICATIONS

This application claims the benefit of priority from U.S. Provisional Application Ser. No. 62/072,924, filed on Oct. 30, 2014, the entire contents of which is hereby incorporated by reference.

### FIELD

The embodiments described herein are directed to compositions and methods for coating surfaces, including, but not limited to, coating a surface with a hydrophobic coating using alkoxysilanes.

### BACKGROUND

Coated capillaries are needed in various applications. However, current coating processes are complex and difficult to maintain the performance reproducibility. For example, various siloxane reagents are used as the primary coating material for capillaries used in capillary electrophoresis. Manufactures struggle with maintaining the reproducibility of the performance of coated capillaries because of the issues of this primary coating material coming from the vendor. Therefore, performance of capillaries coated using these raw materials are difficult to be maintained from lot-to-lot. Additionally, a second step of this coating process is to attach another hydrophobic or hydrophilic layer to minimize the electroosmotic flow (EOF). In addition to the raw material issue, the number of functional groups available in a polymer affect the coverage of the surface after the second layer is attached. Therefore, run life and lot-to-lot reproducibility is compromised. Accordingly, there is a need for better processes and compositions for coating capillaries and other surfaces.

### BRIEF DESCRIPTION OF DRAWINGS

FIG. 1 illustrates a hydrolysis and polycondensation reaction followed by grafting to the silica surface.

FIG. 2 illustrates a non-limiting embodiment of using a coated surface to separate and detect four markers

FIG. 3 illustrates a non-limiting embodiment of using a coated surface to separate and detect a monoclonal antibody.

### SUMMARY

In some embodiments, methods of coating a surface with a hydrophobic coating are provided. In some embodiments, the methods comprise contacting the surface with a alkoxysilane under conditions sufficient to produce a hydrophobic coated surface.

In some embodiments, methods of coating a surface with a hydrophobic coating are provided, wherein the methods comprise contacting the surface with an acidic aqueous solution comprising a partially hydrolyzed alkoxysilane to produce a hydrophobic coated surface

In some embodiments, compositions comprising a silica surface covalently bound to a alkoxysilane are provided. In some embodiments, the alkoxysilane is a trialkoxylsilane.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims. Unless defined otherwise, all technical and scientific terms used herein have the same meaning as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must also be noted that as used herein and in the appended claims, the singular forms “a,” “an,” and “the” include plural reference unless the context clearly dictates otherwise.

As used herein, the term “about” means plus or minus 10% of the numerical value of the number with which it is being used. Therefore, about 50% means in the range of 45%-55%.

“Optional” or “optionally” may be taken to mean that the subsequently described structure, event or circumstance may or may not occur, and that the description includes instances where the event occurs and instances where it does not.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Embodiments described herein provide for compositions and methods that can be used to produce coated surfaces, such as a hydrophobic coated surface that can be used in the analysis of certain molecules, such as in capillary electrophoresis-mass spectrometry.

The unexpected and surprising advantages of the compositions, coatings, and process is that the coating that is formed on a surface reduce or eliminate an analyte of interest's interaction with the surface, which will increase the levels of detection. Additionally, the embodiments described herein provide for more efficient separation, which in some embodiments, can be achieved with no loss of sample. Another advantage is that the coating will mask the charges of, for example, silanol groups on a surface (e.g. capillary wall) to eliminate electroosmotic flows associated with the charges. This results in enhanced performance reproducibility that can be maintained. Additional advantages include, but are not limited to, the process is a one-step reaction, the coating can be done after etching, resistant to coating degradation due to hydrolysis, coating reagent is commercially available, a single step coating process, the coating reagent forms a network and covalently bonded to the surface of the capillary, and the surface coverage with the coating is uniform. Other advantages will also be apparent from the embodiments described herein.

Accordingly, embodiments provided herein methods of coating a surface with a hydrophobic coating comprising contacting the surface with a alkoxysilane under conditions sufficient to produce a hydrophobic coated surface. In some embodiments, the alkoxysilane is at least partially hydrolyzed. In some embodiments, the alkoxysilane is at least partially hydrolyzed under acidic conditions.

Examples of alkoxysilanes that can be used include, but are not limited to, haloalkylsilanes and any alkoxysilane where functional groups available to form a covalent bond with silanol groups on a silica surface. Examples of such alkoxysilanes include, but are not limited to, trimethoxy(trifluoromethyl)silane, hexadecyltrimethoxysilane, (heptadecafluoro-1,1,2,2-tetrahydrodecyl)trimethoxysilane, 3,3,3-trifluoropropyltrimethoxysilane, (heptadecafluoro-1,1,2,2-tetrahydrodecyl)triethoxysilane, and the like. In some embodiments, the alkoxysilanes is a haloalkylsilane with alkoxy groups. In some embodiments, the alkoxysilane is a haloalkoxysilane. In some embodiments, the silane is a trimethylsiloxane or a trimethoxysilane. In some embodiments, the silane is a trialkylsiloxane or a trialkoxylsilane. In some embodiments, the alkoxysilane has a formula of:

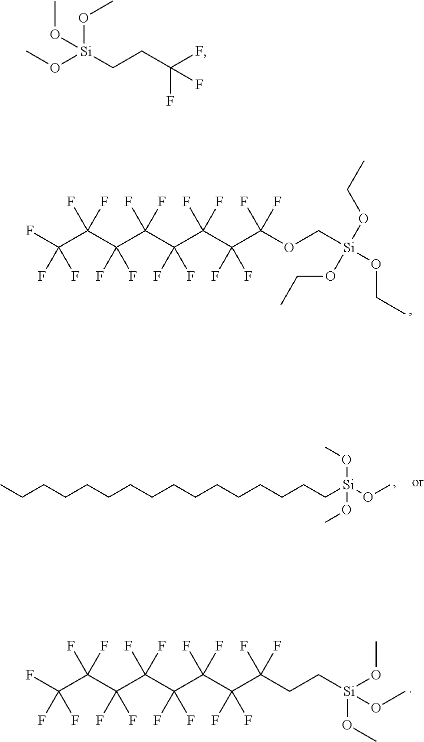

In some embodiments, the alkoxysilanes is hydrolyzed. In some embodiments, the hydrolysis is partial or complete. In some embodiments, the hydrolysis is sufficient when the acidic content is 2.5% v/v.

In some embodiments, the alkoxysilane is contacted with the surface in an aqueous solution comprising an acid. In some embodiments, the alkoxysilane is hydrolyzed. In some embodiments, the hydrolysis is partial or complete. The pH of the solution can be less than 7.0, 6.5, 6.0, 5.5, 5.0, 4.5, or 4.0. In some embodiments, the acid is nitric acid or hydrochloric acid. In some embodiments, the acid is nitric acid.

In some embodiments, the surface is washed prior to being contacted with the silane. In some embodiments, the surface is washed with a base, such as, but not limited to sodium hydroxide. The surface can then be contacted with an inert gas (e.g. argon or helium). The surface can also be washed with water. The surface, which can be a capillary, can be washed or contacted with these materials under pressure. In some embodiments, the pressure is about 20 psi.

In some embodiments, the alkoxysilane is contacted with the surface under gradual heating. In some embodiments, the surface and the alkoxysilane is heated after the surface is incubated with the alkoxysilane for a period of time. In some embodiments, the heating is performed at least 15, 30, 60, 90, or 120 minutes after the surface is contacted with the alkoxysilane. In some embodiments, the heating is performed about 1-2 hours after the surface is contacted with the silane. In some embodiments, the reaction of reacting the alkoxysilane with the surface is driven to completion. That is, the alkoxysilane present in the reaction is exhausted and bound to the surface. In some embodiments, to drive the reaction to completion a higher temperature is needed. Therefore, in some embodiments, gradual heating is performed to react the alkoxysilane with the surface. Without wishing to be bound to any particular theory, hydrolysis of the halo groups or alkoxy groups of the alkoxysilane attaching to a Si group on the surface starts hydrolyzing slowly in, for example, an acidic aqueous medium when the medium is at room temperature. While the hydrolysis reaction is in progress, it triggers polycondensation reaction. This can be illustrated with the following schematic:
1) X—Si→HO—Si Hydrolysis
2) Si—OH+HO—Si→Si—O—Si+H₂O Polycondensation

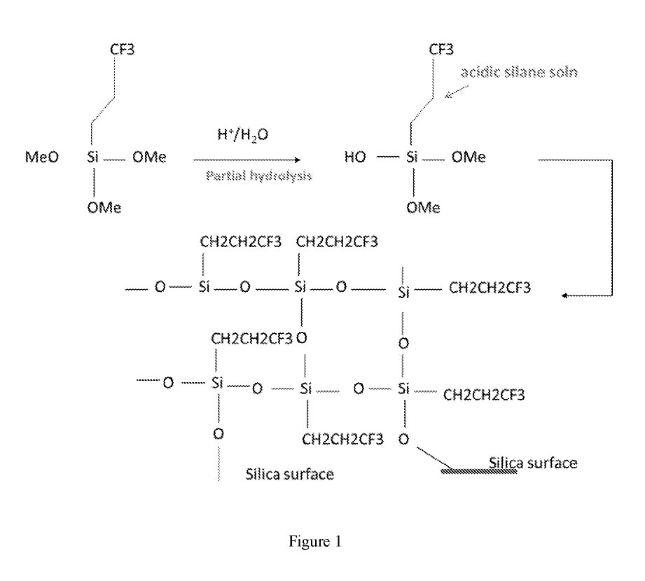

In some embodiments, reaction 1 can start at ambient temperature (for example, 20-25° C.) but completion takes a longer time as compared to when the reaction is performed at a higher temperature (for example, greater than about 50° C.). In some embodiments, reaction 2 requires a higher temperature (for example, greater than about 70° C.). Gradual heating can be used to regulate hydrolysis and polycondensation simultaneously. The gradual heating can be used to generate, for example, a uniform network of polymer while the polymer is attached to the surface via surface silanol groups. This is also illustrated in FIG. 1. The reactions can be gradually heated to a temperature of about 100° C. However, the temperature can be increased to above 100° C. if needed.

In some embodiments, the surface is heated in a step gradient. In some embodiments, the surface is heated at a first temperature for a period of time and then a second temperature for a second period of time. In some embodiments, the first and second periods of time are the same. In some embodiments, the first and second periods of time are different. In some embodiments, the first temperature is about 60 C, about 70 C, about 80 C, about 60-80 C, about 65-75 C, or about 70-80 C. In some embodiments, the second temperature is about 120 C, about 110-130 C, about 115 to about 125 C, or about 120-130 C. In some embodiments, the first period of time or second period of time is about 12-20 hours, about 12-18 hours, about 12-16 hours, about 12-14 hours, about 14-20 hours, about 14-18 hours, about 14-16 hours, about 16-20 hours, about 16-18 hours. In some embodiments, either period of time is about 1-10 hours, about 1-8, about 1-6, about 1-4, about 1-3, about 1-2, or about 1 hour. In some embodiments, either period of time is about 2-10 hours, about 2-8, about 2-6, about 2-4, about 2-3, or about 2 hours. In some embodiments, either period of time is about 3-10 hours, about 3-8, about 3-6, about 3-4, or about 3 hours. In some embodiments, either period of time is about 4-10 hours, about 4-8, about 4-6, or about 4 hours. In some embodiments, the surface is heated at the first temperature as described herein for about 14-18 hours and then at a second temperature as described herein for about 2-6 hours.

The method can be used to provide a hydrophobic coated surface. The hydrophobic coated surface can be, for example, a surface that is covalently bound to the alkoxysilane. In some embodiments, the surface can be a silica surface. A “silica surface” is any surface with reactive silica groups that can form covalent bonds with the alkoxysilane. In some embodiments, the surface is glass. In some embodiments, the surface is a capillary surface. In some embodiments, the capillary is a capillary suitable for capillary electrophoresis.

In some embodiments, the contacting comprises passing the alkoxysilane in an acidic aqueous solution over the surface. In some embodiments, the acidic aqueous solution comprises hydrolyzed alkoxysilanes as described herein. In some embodiments, the surface is an interior surface of a capillary. In some embodiments, the contacting comprises passing the alkoxysilane through the interior surface of the capillary. The solution can be passed over the surface in any manner that is sufficient to coat the surface. This can be a wash or bathing technique or any other process. For example, the silane can be contacted with the surface for a period of time (e.g. about 1 to about 2 hours). The silane can be replenished to compensate the decrease of reagent around the solid surface as the reagent forms covalent bonds. In some embodiments, such as for capillary coating, the coating solution (the solution containing the silanes) is pushed through the capillary at about 50 μL/min flow rate for about 1-2 hours at room temp. In some embodiments, the capillaries can then be flushed with an inert gas (e.g., He or Ar) to remove any unused silane. The capillary can be flushed with the inert gas for any time that is sufficient for this purpose. In some embodiments, the time is about 10 min. As described herein, the surface can then be heated, such as, but not limited to, the methods described herein.

As described herein, in some embodiments, the contacting with the surface is performed under gradual heating.

Embodiments provided herein also provide methods of coating a surface with a hydrophobic coating comprising contacting the surface with an acidic aqueous solution comprising a partially hydrolyzed alkoxysilane to produce a hydrophobic coated surface. In some embodiments, the hydrophobic coated surface is a hydrophobic coated silica surface. In some embodiments, the hydrophobic coated surface is a hydrophobic coated glass surface. In some embodiments, the hydrophobic coated surface is a hydrophobic coated capillary surface. In some embodiments, the hydrophobic coated surface is an interior surface of the capillary. In some embodiments, the contacting is done under gradual heating as described herein.

As described herein various steps are described with regards to the methods. In some embodiments, the steps can be performed in sequence or simultaneously. For example, in some embodiments, the haloalkylsilanes or alkoxysilanes are partially or completely hydrolyzed. After the hydrolysis, the partially or completely hydrolyzed haloalkylsilanes or alkoxysilanes are mixed or contacted with an acidic aqueous solution. Then the acidic solution can be heated and/or contacted with the silica surface. The heating step can also be performed before the solution is contacted with the silica surface.

Compositions comprising a silica surface covalently bound to a alkoxysilane are also provided. In some embodiments, the alkoxysilane is trimethoxy(trifluoromethyl)silane. The silica surface can be a capillary surface, such as, but not limited to, the interior of the capillary surface. The compositions or surfaces can be prepared according to the methods described herein.

Systems comprising the coated surface are also provided. In some embodiments, a mass spectrometer comprising the coated surface is provided. In some embodiments, the mass spectrometer is one used for capillary electrophoresis mass spectrometry. In some embodiments, the mass spectrometer comprises a coated capillary as described herein.

### Examples

### Example 1

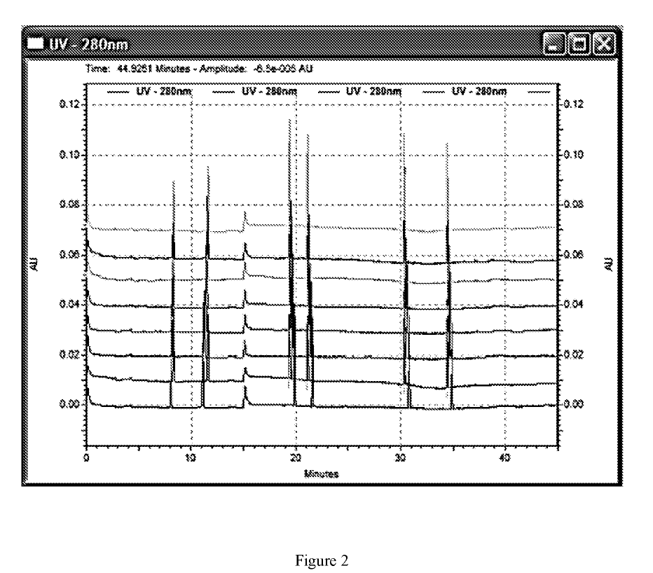

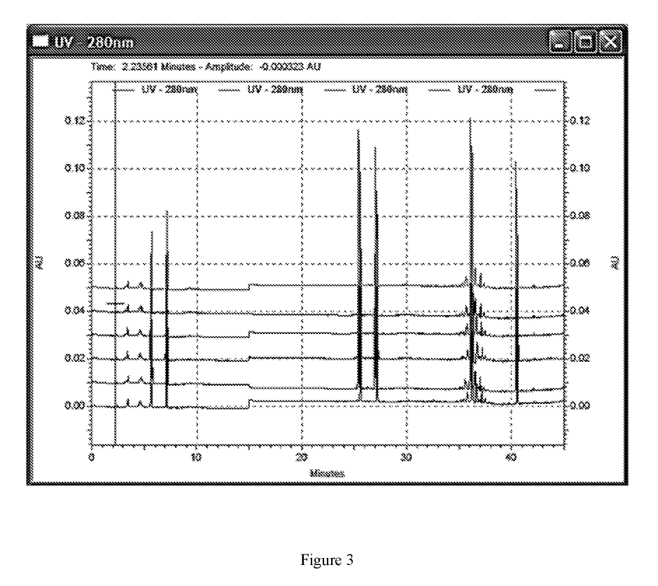

Coating of Surface Materials for capillary coating: Ethanol, Fluorocarbon siloxane, and 1 M nitric acid. Capillary coating procedure: Coating solution mixture was prepared by mixing 1.5 μL of Ethanol with 2 mL of the siloxane reagent and 50 μL of nitric acid. Capillary was first rinsed for 30 min with 1M NaOH at 20 psi followed by distilled water for another 30 min at the same pressure. Flushed the capillary with argon gas for 30 min at 20 psi and then the coating solution was passed through the capillary for 2 h at room temperature. Then the capillary was heated at 80 C for 18 h and further heated at 120 for another 3 h. After heating the capillary was allowed to come to room temperature and then rinsed for 15 min with methanol at 50 psi. The capillary was then successfully used in a CIEF experiment to generate spectra such as those shown in FIGS. 2 and 3.

Various references and patents may be disclosed herein, each of which are hereby incorporated by reference for the purpose that they are cited.

From the foregoing, it will be appreciated that various embodiments of the present disclosure have been described herein for purposes of illustration, and that various modifications can be made without departing from the scope and spirit of the present disclosure. Accordingly, the various embodiments disclosed herein are not intended to be limiting.

What is claimed is:

1. A method of coating a surface with a hydrophobic coating comprising contacting the surface with an alkoxysilane that is at least partially hydrolyzed under conditions sufficient to produce a hydrophobic coated surface.

2. The method of claim 1, wherein the alkoxysilane is at least partially hydrolyzed under acidic conditions.

3. The method of claim 1, wherein the alkoxysilane is contacted with the surface under gradual heating.

4. The method of claim 3, wherein the gradual heating is step gradient heating.

5. The method of claim 1, wherein the alkoxysilane is contacted with the surface in a aqueous solution comprising an acid and the pH of the solution is less than 7.0.

6. The method of claim 5, wherein the acid is nitric acid or hydrochloric acid.

7. The method of claim 1, wherein the hydrophobic coating is covalently bound to the surface.

8. The method of claim 7, wherein the surface is a silica surface.

9. The method of claim 7, wherein the surface is glass.

10. The method of claim 7, wherein the surface is a capillary surface.

11. The method of claim 1, wherein contacting comprises passing the alkoxysilane in an acidic aqueous solution over the surface.

12. The method of claim 11, wherein the surface is an interior surface of a capillary.

13. The method of claim 12, wherein contacting comprises passing the alkoxysilane through the interior surface of the capillary.

14. The method of claim 13, wherein the alkoxysilane is a haloalkoxysilane.

15. The method of claim 13, wherein the alkoxysilane is a trialkoxylsilane.

16. The method of claim 13, wherein the alkoxysilane is trimethoxy(trifluoromethyl)silane, hexadecyltrimethoxysilane, (heptadecafluoro-1,1,2,2-tetrahydrodecyl)trimethoxysilane, 3,3,3-trifluoropropyltrimethoxysilane, or (heptadecafluoro-1,1,2,2-tetrahydrodecyl)triethoxysilane.

17. The method of claim 1, wherein the hydrophobic coated surface is a hydrophobic coated capillary surface.

18. The method of claim 17, wherein the surface is an interior surface of the capillary.

19. The method of claim 18, wherein the alkoxysilane is a haloalkoxysilane or a trialkoxysilane.

20. The method of claim 18, wherein the alkoxysilane is trimethoxy(trifluoromethyl)silane, hexadecyltrimethoxysilane, (heptadecafluoro-1,1,2,2-tetrahydrodecyl)trimethoxysilane, 3,3,3-trifluoropropyltrimethoxysilane, or (heptadecafluoro-1,1,2,2-tetrahydrodecyl)triethoxysilane.
